(19) United States
(12) Patent Application Publication
(10) Pub. No.: US 2013/0194793 A1
(43) Pub. Date: Aug. 1, 2013

(54) MARKING PROJECTOR

(71) Applicant: SOLA-Messwerkzeuge GmbH, Gotzis (AT)

(72) Inventor: Oliver BERTSCH, Dornbirn (AT)

(73) Assignee: SOLA-MESSWERKZEUGE GMBH, Gotzis (AT)

(21) Appl. No.: 13/752,874

(22) Filed: Jan. 29, 2013

(30) Foreign Application Priority Data
Jan. 30, 2012 (AT) A 119/2012

(51) Int. Cl. F21V 8/00

(52) U.S. Cl. CPC G02B 6/0001
USPC 362/231; 362/235

(57) ABSTRACT

A marking projector, in particular a building projector, comprising at least one light generating device and at least one light coupling-out device for coupling at least a part of the light generated by the at least one light generating device out of the marking projector, wherein the at least one light coupling-out device is light-conductingly connected to the at least one light generating device by way of at least one beam path, wherein at least a part of the at least one beam path between the at least one light generating device and the at least one light coupling-out device extends through a fluid or gel-like light guide which is hardened on the surface of an areal substrate.

The invention concerns a marking projector, in particular a building projector, comprising at least one light generating device and at least one light coupling-out device for coupling at least a part of the light generated by the at least one light generating device out of the marking projector, wherein the at least one light coupling-out device is light-conductingly connected to the at least one light generating device by way of a beam path.

Marking projectors of the general kind set forth are used for example for generating one or more lines visible on a wall (or one or more points) or a grid network. To provide that the visible line actually extends horizontally the marking projectors can be provided with means which allow compensation of a floor inclination (for example height-adjustable feet which are mounted on the bottom plate, a swinging suspension for the light generating device or motorized adjustability of the light generating device) and thus provide for vertical orientation of the marking projectors. Marking projectors of the general kind set forth can also be used to mark slopes, inclinations or the like.

If the marking projectors are adapted for use on building sites they are also referred to a building projectors.

Marking projectors of the general kind set forth are to be found for example in EP 1 759 172 B1 (concerns a scanner), CN 2 348 353 Y, EP 1 484 578 A1 and AT 506 924 A2.

In the state of the art the beam paths between the at least one light generating device and the at least one light coupling-out device extend freely in the interior of the housing of the marking projector. Various optical elements such as for example collimation lenses, converging lenses or diverging lenses are arranged in the beam path to adjust the geometrical properties of the light beam, whereby it is relatively difficult to correctly adjust the beam paths. In addition this requires a relatively large amount of space in the marking projector and thus involves the need for a relatively large housing for the marking projector.

The object of the invention is to develop a marking projector of the general kind set forth in such a way that the beam path between the at least one light generating device and the at least one light coupling-out device can be simpler and thus more easily adjustable and more compact than in the state of the art.

That object is attained by a marking projector having the features of claim 1. Further advantageous embodiments of the invention are defined in the appendant claims.

The geometrical properties of the light beam can be easily controlled by the use of a fluid or gel-like light guide which is hardened on the surface of an areal substrate, for guiding the light beam between the light generating device and the light coupling-out device. That affords a reduced level of adjustment complication and expenditure.

In addition the simple configuration of the beam path (ideally it extends substantially completely in the light guide along the areal substrate) affords a reduced structural size for the marking projector according to the invention in comparison with the state of the art.

In comparison with a light guide in the form of a glass fiber cable the use of the fluid or gel-like light guide which is hardened on the surface of an areal substrate gives the advantage that a rigid substrate involving predetermined geometrical properties which can no longer be altered can be used, which facilitates calibration of the beam path in the factory and excludes deterioration and impairments in the event of use on the building site or the like. Alternatively it is possible to use a flexible substrate which, by means of suitable mechanical fixing, also enjoys the above-mentioned advantages.

It is to be noted that the light guide is admittedly arranged on the surface of a substrate, but does not always have to be disposed on the uppermost surface of a component. In other words for example the substrate and/or the light guide could be coated with a protective layer.

Fluid or gel-like light guides which are hardened on the surface of an areal substrate, for use in the invention—for example comprising a UV-hardened polymer—are known from the state of the art (see for example EP 2 219 059 A2, EP 1 715 368 B1, EP 0 990 931 B1, EP 0 911 658 B1, EP 1 312 948 B1 and DE 197 32 506 A1). In that sense the fluid or gel-like light guides which are hardened on the surface of an areal substrate can also be referred as polymeric light guides.

Substrates provided with hardened, fluid or gel-like light guides can be obtained for example from vario-optics ag, Mittelbissaustrasse 7, CH-9410 Heiden.

In the state of the art such light guides are used in particular in so-called electro-optical circuit boards and serve for data transmission by means of light. As those electro-optical circuit boards are flat reference is often also made to planar light waveguides (to distinguish them from glass fiber cables).

In accordance with the invention the use can be implemented on substrates without electric components, for example on bare circuit boards. In the case of using flat substrates the light guides according to the invention can also be characterized as planar light waveguides. The use of substrates which are at least portion-wise curved is however not excluded in the case of the invention. Rather, desired deflections in the beam path can be achieved in that way by the use of one or more correspondingly curved areal substrates.

As already stated hereinbefore the areal substrate can be rigid or flexible. A quite particularly preferred embodiment is one in which the areal substrate is portion-wise rigid and portion-wise flexible. The rigid portion can serve as a carrier for the light generating device and possibly for the electronic actuating means of the light generating device. The flexible portion can be in the form of one or more fingers which can be curved by virtue of the flexibility into any desired position, for example to be able to implement orthogonal beam division.

The light guides can be for example of a substantially right-angled cross-section, preferably in a region of between about 10 and 55 μm, particularly preferably between 20 and 50 μm. Other geometries are naturally possible, in which case the dimensioning should be in the above-indicated regions.

At the ends of the areal substrate and optionally in particular the flexible portions, there can be provided mechanical orientation structures which allow passive mounting of the light generating device and possible further optical elements. This functionally involves an adjusting device prior to and/or after the waveguide for the light generating device, and coupling-in or coupling-out devices.

The light generating device used can be for example a laser diode, a laser chip or an LED, each particularly preferably emitting in the red or green spectral range.

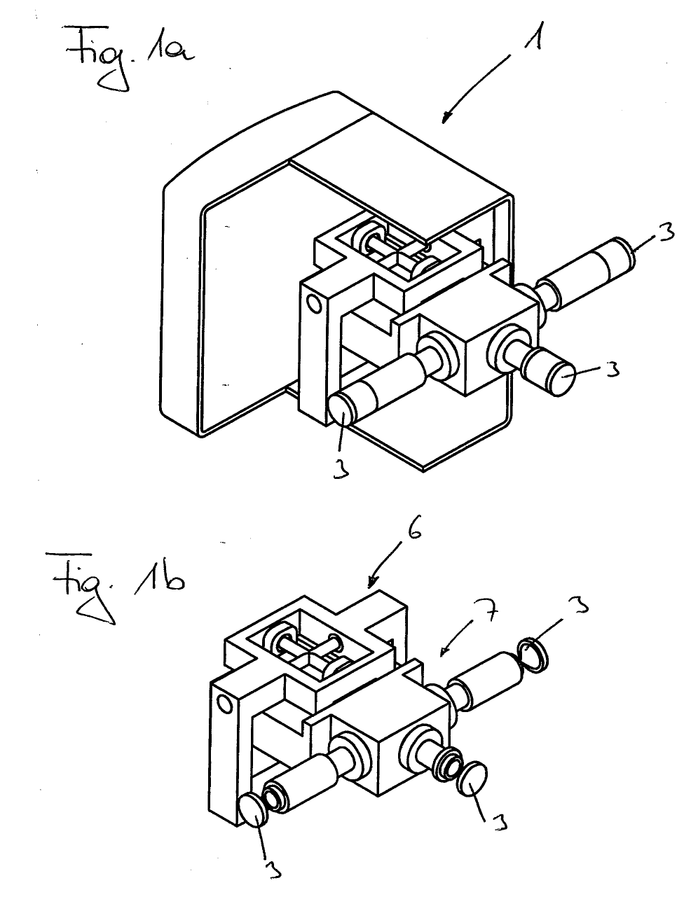

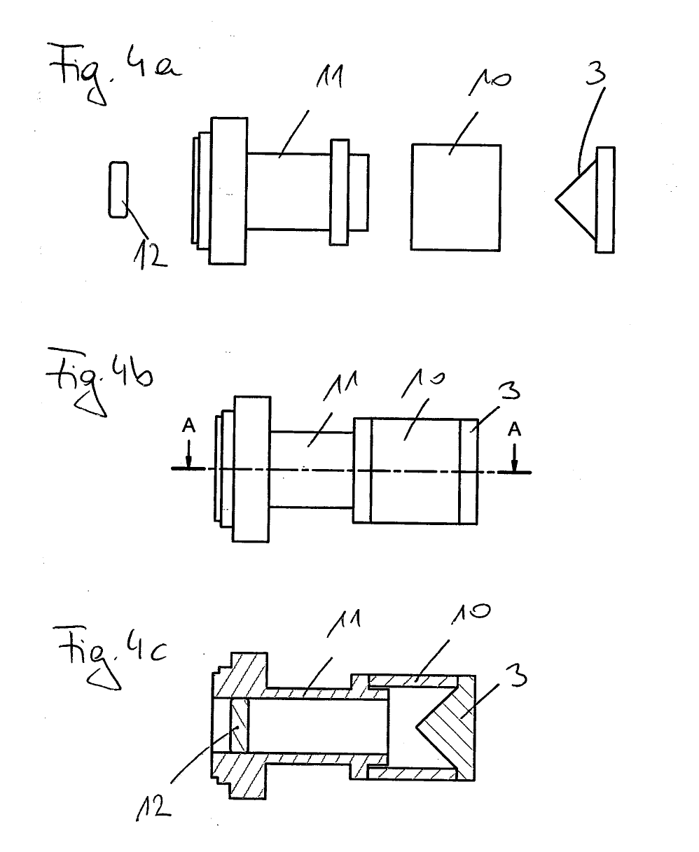

The light coupling-out device can be in the form of means for deflecting, fanning out or expanding light, in particular in the form of a collimation lens, a pentaprism, a reflecting convex or concave cone (see for example FIGS. 1 and 17 of U.S. Pat. No. 4,111,564), but also diffractive optical elements. It is alternatively also possible to provide a simple window.

The number of light generating devices and/or light coupling-out devices can be selected differently depending on the respective desired primary purpose of use of the marking projector and/or the strength of the light generating devices.

Marking projectors are frequently used, which generate two or three light planes arranged orthogonally relative to each other. It is relatively expensive if a dedicated light generating device is used for each light plane. That can be avoided for example by the use of a single light generating device which is sufficiently strong, in combination with a plurality of light coupling-out devices.

In principle however it is also in accordance with the invention to use one, two, three or more units each comprising a light generating device and a light coupling-out device. In that case therefore each light plane is produced independently of the optionally present other light planes.

It will be appreciated that, in the case of three light planes, it is also conceivable to use two—possibly weaker—light generating devices, one of the two light generating devices being coupled to two light coupling-out devices. No matter whether only one or two light generating devices is used, in both cases there are provided at least two light coupling-out devices which are light-conductingly connected to a light generating device.

It is precisely in that case (but not just there) that it may be advantageous if it is provided that at least a part of the beam path between each of the at least two light coupling-out devices and the light generating device extends through a common portion of the fluid or gel-like light guide which is hardened on the surface of the areal substrate.

In that case it can be provided that the light guide is divided after the common portion (main light guide) into branchings leading to the at least two light coupling-out devices.

Alternatively or additionally it can also be provided that two separate areal substrates with light guide arranged thereon are arranged in at least one beam path. For example two substrates can be arranged orthogonally to each other in the marking projector, in which case the beam path extends between the substrates by way of an optical deflection element (for example 45° mirror).

The light guide can be divided in various ways. For example it can be provided that all branchings therefrom begin to leave at one location. The simplest is the provision of straight branchings therefrom, for example with the same cross-section for the main light guide and the branchings.

A further variant is the use of curved branchings, preferably also extending from one location.

For coupling the light generated by the at least one light generating device into the light guide, generally an optical coupling-in means (for example a converging lens) will be necessary to be able to achieve adequate efficiency. In principle however direct coupling-in is also possible without an optical coupling-in means. In that case the light generating device must be placed as closely as possible to the entry to the light guide in order to be able to couple in as much light as possible. It is also conceivable for the light of a light generating device to be coupled into two or three straight, mutually separated light guides directly, that is to say without using an optical coupling-in means.

From the light guide the light can pass to the at least one light coupling-out device directly, that is to say without using an optical coupling-out means. It will be appreciated that correcting optical elements could also be provided here.

Further advantages and details of the invention will be apparent from the Figures and the accompanying description.

In the Figures:

FIG. 1a is shows a diagrammatic perspective view of a marking projector with the housing partly broken away,

FIG. 1b shows an isolated view of the optical assembly together with its mounting,

FIG. 1c is shows a partial exploded view of the device shown in FIG. 1b,

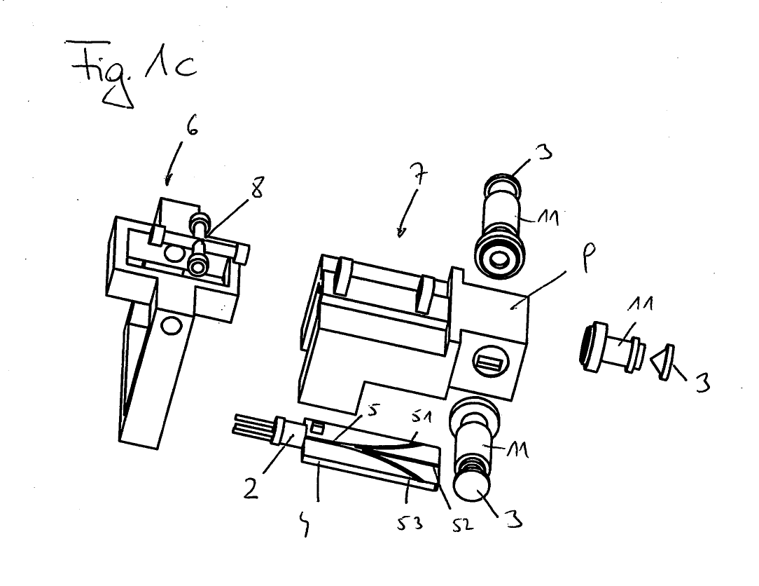

FIGS. 2a through 2c show three different views of a detail which can be seen in FIG. 1c,

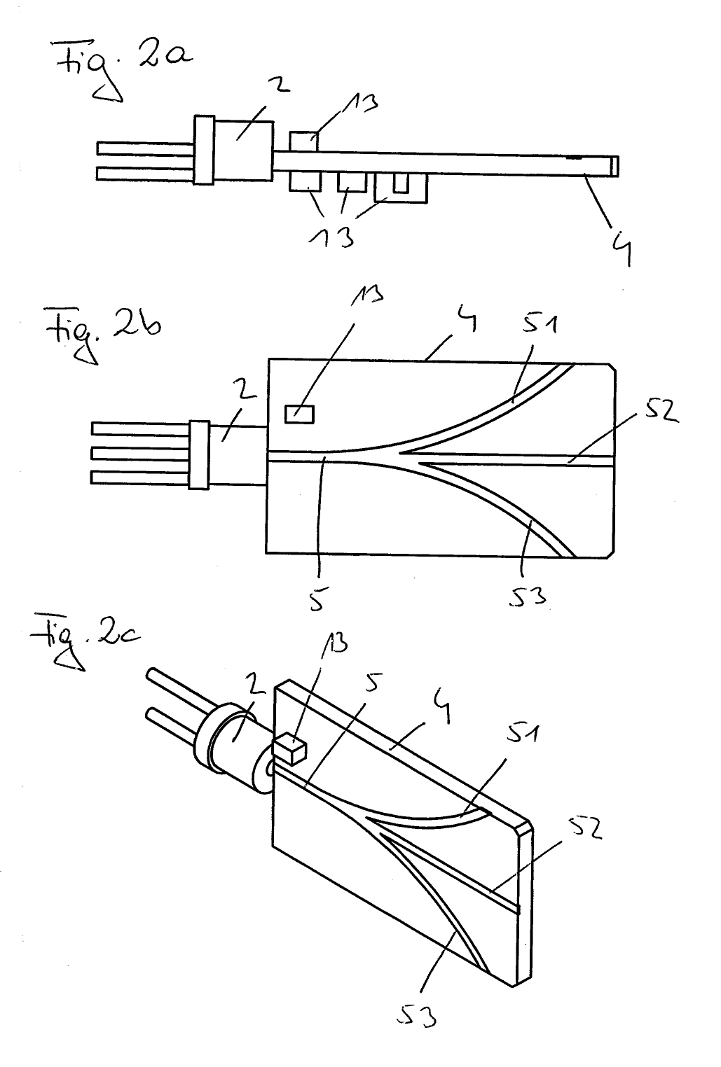

FIGS. 3a through 3c show various views of a variant of the detail shown in FIG. 2, and

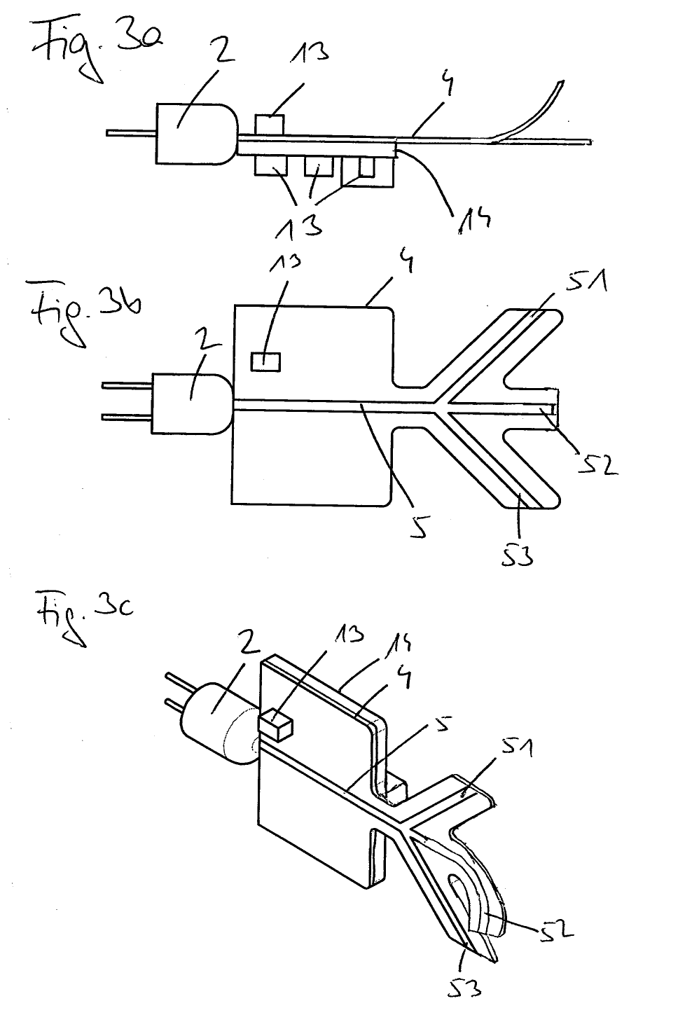

FIGS. 4a through 4c show a further detail from the view in FIG. 1c is as an exploded view, a side view and a sectional view.

FIG. 1a is diagrammatically shows a marking projector 1 with a partly broken-away housing. Only those components which are of significance for the invention are shown, namely an optical assembly 7 which is mounted cardanically in the housing of the marking projector 1 at a mounting 6. Instead of the cardanic mounting 6, as discussed in the introductory part of the description it is also possible to take other or no measures at all for compensating for floor slope or the like.

As can be seen in particular from FIG. 1c is the optical assembly 7 is cardanically supported by way of an axis cross arrangement 8 of the mounting 6. The optical assembly 7 has a holder 9 to which the assemblies of the optical assembly 9, that are shown in greater detail in the Figures hereinafter, are held.

The light guide 5 which is shown in FIGS. 2 and 3 in two different embodiments and which is hardened on the surface of an areal substrate 4 is of particular significance.

Reference sign 13 denotes electronic devices.

In the variant in FIG. 2 the light guide 5 extends between a light generating device 2 with formation of three branchings 51, 52, 53 therefrom, to the light coupling-out devices 3 which are not shown in FIG. 2. The branchings 51 and 53 are of a curved configuration in FIG. 2.

As a difference in relation thereto, in the variant in FIG. 3 all branchings 51, 52, 53 are straight. The common portion (main light guide) of the light guide 5 is longer than in FIG. 2.

In the variant in FIG. 3 the areal substrate 4 in itself is completely flexible, but is rigidly fixed portion-wise by a stiffening element 14. By virtue of the flexible configuration of the areal substrate 4 it is possible for the areal substrate 4 to be at least portion-wise of a curved configuration, as is shown by way of example for the areal substrate 4 in the region of the branching 52. After the areal substrate 4 is bent away in the flexible portion to the desired extent the individual portions can also be fixed in their position by stiffening means of a suitable configuration (this is not shown).

FIG. 4b shows a side view of the light coupling-out device 3 which is connected to an optical coupling-out means 12 by way of a transparent window 10 and a tube 11 and can be fixed as a unit with all the components to the holder 9. In this embodiment the light coupling-out device 3 is in the form of a reflecting cone.

FIG. 4c shows a sectional view in FIG. 4b along the line A-A.

1. A marking projector, in particular a building projector, comprising at least one light generating device and at least one light coupling-out device for coupling at least a part of the light generated by the at least one light generating device out of the marking projector, wherein the at least one light coupling-out device is light-conductingly connected to the at least one light generating device by way of at least one beam path, characterized in that at least a part of the at least one beam path between the at least one light generating device and the at least one light coupling-out device extends through a fluid or gel-like light guide which is hardened on the surface of an areal substrate.

2. A marking projector as set forth in claim 1 characterized in that the areal substrate is flat.

3. A marking projector as set forth in claim 1 characterized in that the areal substrate is at least portion-wise of a curved configuration.

4. A marking projector as set forth in claim 1 characterized in that the areal substrate is at least portion-wise rigid and portion-wise flexible.

5. A marking projector as set forth in claim 1 characterized in that there are provided at least two light coupling-out devices which are light-conductingly connected to the at least one light generating device.

6. A marking projector as set forth in claim 5 characterized in that at least a part of the beam path between each of the at least two light coupling-out devices and the at least one light generating device extends through a common portion of the fluid or gel-like light guide which is hardened on the surface of the areal substrate.

7. A marking projector as set forth in claim 6 characterized in that the light guide is divided after the common portion into branchings leading to the at least two light coupling-out devices.

8. A marking projector as set forth in claim 1 characterized in that the at least one light generating device is in the form of a laser diode, laser chip or LED.

9. A marking projector as set forth in claim 1 characterized in that the at least one light coupling-out device is in the form of means for deflecting, fanning out or expanding light, in particular in the form of a collimation lens, a pentaprism, a reflecting cone, a diffractive optical element or a simple window.

10. A marking projector as set forth in claim 1 characterized in that there is provided an optical coupling-in means for coupling light generated by the at least one light generating device into the light guide.

11. A marking projector as set forth in claim 1 characterized in that light generated by the at least one light generating device is coupled directly into the light guide without the use of an optical coupling-in means.

12. A marking projector as set forth in claim 1 characterized in that there are provided at least two light generating devices which differ from each other in the wavelength of the delivered light, wherein the light of the at least two light generating devices extends through separate light guides or the same light guide.
